(19) United States
(12) Patent Application Publication
(10) Pub. No.: US 2008/0119339 A1
(43) Pub. Date: May 22, 2008

(54) Quick change end of arm tool attachment

(76) Inventor: Michael J. Oliver, Greenville, RI (US)

Correspondence Address: BROMBERG & SUNSTEIN LLP, 125 SUMMER STREET, BOSTON, MA, 02110-1618, US

(21) Appl. No.: 11/600,686

(22) Filed: Nov. 16, 2006

(51) Int. Cl. B23Q 3/155

(52) U.S. Cl. 483/1; 483/19; 901/41

(57) ABSTRACT

An end of arm tool changing system, the system comprising a male retaining member for use on an end-of-arm tool, and a female locating member for use on a robotic arm. The male retaining member includes a flange having at least a convex semi-circular portion. The includes a rim defining a channel having at least a concave semi-circular portion and capable of receiving the flange for coupling the end-of-arm tool to the robotic arm.

### FIELD OF THE INVENTION

The invention generally relates to end of arm tools for robotic arms. More specifically, the invention relates to the changing of end of arm tools quickly and without the use of additional tools.

### BACKGROUND ART

Automated molding machines are used in the manufacturing industry to produce a wide range of parts and products. Many of these molding systems and machines utilize robotic arms to aid in the manipulation of the many components and workpieces involved in the molding processes. Typically, “end of arm tools”, otherwise known as EOATs, are attached to the robotic arms to help perform specific tasks within the molding process. Each of these EOATs is typically designed to perform a specific task, and needs to be changed when a new and different task needs to be performed.

Some of the prior art EOAT systems do not allow for the changing out of end-of-arm tools, making the systems inflexible. Others are problematic in that they provide for the removal of the EOAT, but the removal process is complicated and time consuming. In such systems, the change-over process typically requires the use of additional tools to remove the attached tool and attach a new tool. The time-consuming nature of the change-over process and the need for additional tools result in greater downtime and higher production costs.

Still other prior art system have tried to reduce the complexity and downtime of EOAT systems by providing for an “automatic” tool change process. An example of such a system is offered by RAD corporation. The RAD system allows for the change out of end of arm tools, however, this system uses a pneumatically driven locking mechanism. The locking mechanism requires pressurized air to “lock” the end of arm tool and the robotic arm. To “unlock” the end of arm tool from the robotic arm, the user must supply air pressure to an “unlocking port”. The need for pressurized air is problematic in that such a system cannot be used in areas that pressurized air is either not available or not permitted. The RAD system is also problematic in that, once the end of arm tool is locked in place, it cannot be adjusted without unlocking the tool, which, as mentioned above, requires supplying pressurized air to the unlocking port.

Therefore, a system that allows for quick removal and replacement of an EOAT would be beneficial in that it can greatly reduce production time and cost. Additionally, the use of such a system would not be limited to areas with pressurized air.

### SUMMARY OF THE INVENTION

In accordance with one aspect of the present invention, a system is provided for the quick change of an end of arm tool. The system includes a male retaining member and a female locating member. The male retaining member is for use on an end-of-arm tool and may include a flange having at least a convex arcuate portion. In some embodiments, the flange may be circular. In other embodiments, the flange may be semi-circular. The female locating member is for use on a robotic arm, and may include a rim defining a channel. The channel may have at least a concave arcuate portion and may be capable of receiving the flange in order to couple the end-of-arm tool to the robotic arm. The male retaining member may be rotatable within the female locating member to allow for alignment of the end of arm tool with respect to the robotic arm.

In various alternative embodiments, the female locating member may further include a center pivoting pin configured to center the male retaining member and attached end of arm tool when the flange is located within the channel. In embodiments with a center pivoting pin, the male retaining member includes an alignment groove configured to slide over and rotate about the center pivoting pin and ensure the male member is centered in the female member.

A plurality of clamps disposed about a perimeter of the female locating member may also be included. The plurality of clamps may be configured to secure the male retaining member in the channel of the female locating member. In some embodiments, the clamps may be spring loaded cam fingers. The plurality of clamps may be tightened and loosened using a plurality of locking levers. By turning the plurality of locking levers, spring tension within the plurality of clamps may be tightened or released.

In accordance with another aspect of the present invention, a quick change end of arm tool is provided. The end of arm tool includes a male retaining member with a flange having at least a convex arcuate portion. In some embodiments, the flange may be semi-circular. In other embodiments, the flange may be circular. The flange may be configured to slide into a rim defining a channel located on a female locating member. The channel may have at least a concave arcuate portion. The male retaining member may be integral to the end of arm tool. Alternatively, the quick change end of arm tool may include a mounting plate located to which the male retaining member may be securedly attached. The male retaining member may have an alignment groove configured to slide over and rotate about a centering pin on the female locating member.

In accordance with another aspect of the present invention, a robot including a robotic arm with a quick-change female locating member is provided. The quick-change female locating member may include a rim defining a channel having at least a concave arcuate portion. The channel may be capable of receiving a flange located on a male retaining member, located on an end-of-arm tool. The quick-change female locating member may be removeably attached to the robotic arm. The female locating member may also have a centering pin configured to center an attached end-of arm tool and male retaining ring.

The female locating member may also have a plurality of clamps disposed about a perimeter of the female locating member. The clamps may be spring loaded cam fingers and may be configured to secure a male retaining member in the channel. A plurality of locking levers associated with the plurality of clamps and configured to tighten and release spring tension within the plurality of clamps may also be included.

In accordance with another aspect of this invention, a male retaining member for a quick change end-of-arm tool system is provided. The male retaining member includes a plurality of threaded holes and a flange. The plurality of threaded holes are for receiving bolts and attaching the male retaining member to an end-of-arm tool. The flange may have a convex arcuate portion and may be configured to slide into a rim defining a channel located on a female locating member. In some embodiments, the flange may be semi-circular. In still other embodiments, the flange may be circular. The male retaining member may also have an alignment groove configured to slide over and rotate about a centering pin located on the female locating member.

In accordance with a further aspect of the present invention, a female locating member for a quick change end-of-arm tool system is provided. The female locating member includes a plurality of bolt holes, and a rim defining a channel. The plurality of bolt holes may be configured to receive bolts and, thereby, attach the female locating member to a robotic arm. The rim defining a channel may have a concave arcuate portion and may be capable of receiving a flange located on a male retaining member and having a convex arcuate portion.

The female locating member may also include a plurality of clamps disposed about a perimeter of the female locating member. The clamps secure the flange and male retaining member within the channel. The clamps may be spring loaded cam fingers and may be associated with a plurality of locking levers. The locking levers can tighten and release spring tension within the plurality of spring loaded clamps. The female locating member may also have a center pivoting pin configured to center the male retaining member when the flange is located within the channel.

In accordance with another aspect of the present invention, a method for the quick change of an end of arm tool is provided. The method includes sliding a flange located on a first male retaining member out of a rim defining a channel located on a female locating member. The first male retaining member is attached to a first end of arm tool and the female locating member is attached to a robotic arm. Once the first end of arm tool is removed, the new end of arm tool can be installed by sliding a second male retaining member, attached to a second end of arm tool, into the female locating member such that a flange located on the second male retaining member is located within the channel. In some embodiments, the female locating member may include a center pivoting pin and the male retaining member may include an alignment groove. In such embodiments, the method also includes rotating the first end of arm tool such that the alignment groove on the first male retaining member may slide over the centering pin. The user can then slide the alignment groove on the second male retaining member over the centering pin so that the flange sits within the channel. The second male retaining member and second end of arm tool can then be rotated such that the alignment groove on the second male retaining member may no longer slide over the centering pin. Rotating the first and second end of arm tools may include rotating the end of arm tools 180 degrees.

The locking levers, located on a perimeter of the female locating ring, can be turned in a first direction to release spring tension in the clamps and release the first male retaining member, allowing the first male retaining member to be rotated and removed. The locking levers can then be turned in a direction opposite of the first direction to increase spring tension in the plurality of spring loaded clamps and apply pressure to the second male retaining member, centering the second end-of-arm tool and securing the second male retaining member and attached second end of arm tool to the female locating member.

### BRIEF DESCRIPTION OF THE DRAWINGS

The foregoing and advantages of the invention will be appreciated more fully from the following further description thereof with reference to the accompanying drawings wherein:

FIG. 1 shows a female locating member attached to a robotic arm in accordance with an embodiment of the present invention;

FIG. 2 shows a rear view of a female locating member attached to a robotic arm in accordance with the present invention;

FIG. 3 shows a male retaining ring mounted to an end-of-arm tool in accordance with an embodiment of the present invention;

FIG. 4 shows a male retaining member and female locating member in accordance with an embodiment of the present invention;

FIG. 5 shows the male retaining member secured in the female locating member in accordance with an embodiment of the present invention; and

FIG. 6 shows an end of arm tool attached to a robotic arm using the female locating member and male retaining member in accordance with an embodiment of the present invention.

### DETAILED DESCRIPTION OF SPECIFIC EMBODIMENTS

In embodiments of the present invention, a female locating member on a robotic arm is used to receive a corresponding male retaining member located on an end of arm tool. The female locating member and male retaining member are typically configured in such a way as to allow the end of arm tool to be loosely placed on the robotic arm, adjusted as needed (e.g., rotated and centered), and then locked into place, without the need for additional tools or materials. Such a quick change end of arm tool attachment mechanism facilitates installation, removal, and adjustment of end of arm tools.

In certain embodiments, a centering pin located on the female locating member and a corresponding alignment groove on the male retaining member facilitate initial installation, centering, rotation, alignment, and adjustment of the male retaining member within the female locating member. In certain other embodiments, the female locating member may have a groove in which the male retaining member may be located and a number of clamps to lock the male member in place.

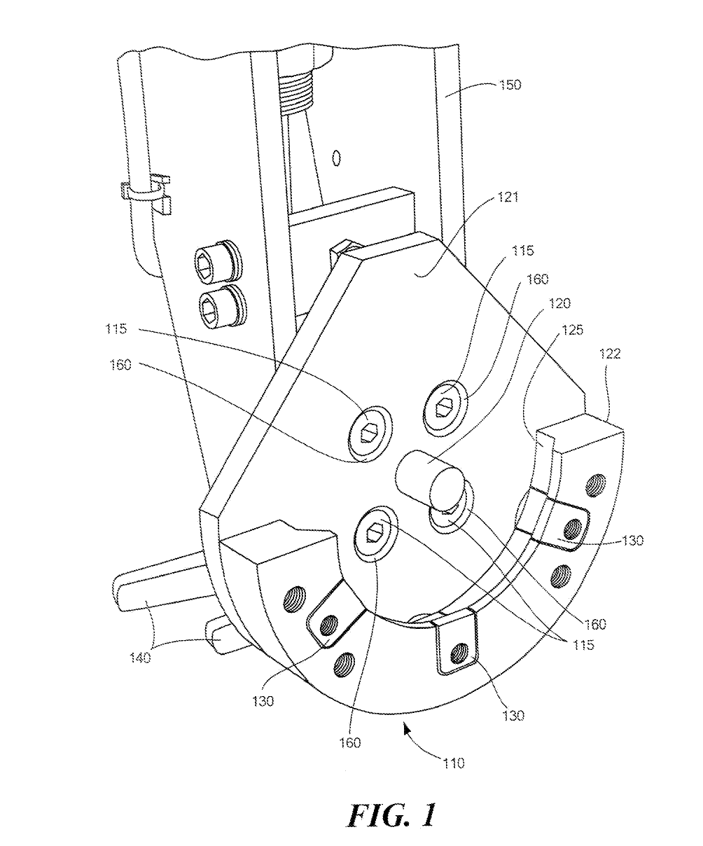

FIG. 1 shows a female locating member 110 for a quick change end of arm tool attachment in accordance with an exemplary embodiment of the present invention. Female locating member 110 includes a rim 122 that is attached to a backplate 121. The rim 122 includes a recessed portion so as to form a semi-circular groove 125 for receiving a corresponding male retaining member (discussed below). The female locating member 110 also includes an optional centering pivot pin 120 onto which the male retaining member may be placed for locating the male retaining member in the female locating member 110 and allowing manual positioning of the male retaining member within the groove 125.

The female locating member 110 is connected to robotic arm 150 using bolts 115 that extend through bolt holes 160 and are secured to a corresponding mounting arrangement on the robotic arm 115. Alternatively, the female retaining member 110 may be integral to the robotic arm 150 or may be attached directly or indirectly to the robotic arm 150 in other ways, for example, by welding, gluing, or clamping, to name but a few.

In order to secure the male retaining member within the female locating member 110, and, more specifically, within the groove 125, the female locating member 110 includes optional clamps 130 and levers 140. In this exemplary embodiment, the clamps 130 are spring-loaded cam fingers that are operated by the levers 140. When the levers 140 are turned in one direction, the clamps 130 are correspondingly moved so as to project inward to secure the male retaining member in the groove 125. When the levers 140 are turned in the other direction, the clamps 130 are moved back to the unlocked position so as to allow movement of the male retaining member (e.g., for repositioning or removal).

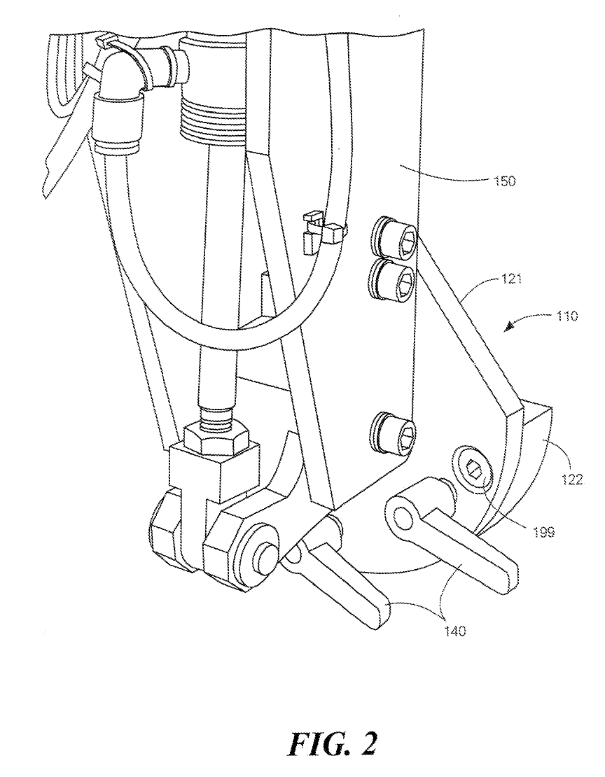

FIG. 2 shows a rear view of female locating member 110. In this view, two of the levers 140 are shown in greater detail. Also, one of the bolts 199 that is used to secure the rim 122 onto the backplate 121 is shown.

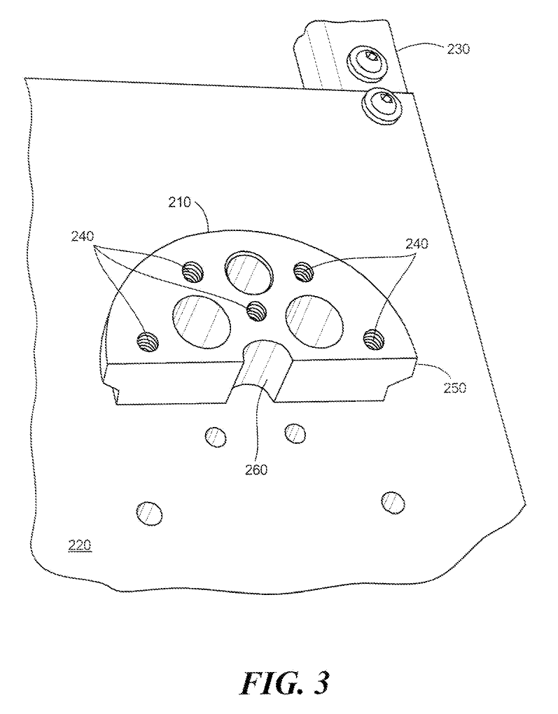

As discussed above, the female locating member 110 is configured to be used with a male retaining member. FIG. 3 shows a first exemplary male retaining member 210 for use with the female locating member 110, in accordance with an embodiment of the present invention. In this embodiment, the male retaining member 210 is semi circular and is mounted to a mounting plate 220, which in turn is mounted to an end of arm tool 230. The male retaining member 210 includes threaded holes 240 by which the male retaining member 210 is bolted to the mounting plate 220 (i.e., from the back side of the male retaining member 210, not shown). Alternatively, male retaining member 210 may be integral to the robotic arm 150 or mounting plate 220 or may be attached directly or indirectly to the robotic arm 150 or mounting plate 220 in other ways, for example, by welding, gluing, or clamping, to name but a few.

The male retaining member 210 has a flange 250 that is configured to fit into the groove 125 located on female locating member 110. Additionally, male retaining member 210 may include alignment groove 260 that is configured to slide over and rotate about centering pivot pin 120. Alignment groove 260 allows male retaining member 210 to be rotated, centered, aligned and adjusted when located within female locating member 110. For reasons discussed below, the male retaining member 210 would typically be oriented on the end of arm tool such that the alignment groove points upward toward the top of the end of arm tool 230.

In order to secure the end of arm tool 230 to the robotic arm 150 using the female locating member 110 and the male retaining member 210, an operator would first place the alignment groove 260 of the male retaining member 210 on the centering pivot pin 120 of the female locating member 110. In this position, the end of arm tool would typically be inverted (i.e., upside-down). The robotic arm 150 would substantially bear the weight of the end of arm tool so as to allow the operator to manipulate the end of arm tool, specifically by rotating the end of arm tool approximately 180 degrees so that the flange 250 is placed within the groove 125. The levers 140 could then be used to lock the male retaining member 215 within the female locating member 110 so as to secure the end of arm tool 230 to the robotic arm 150.

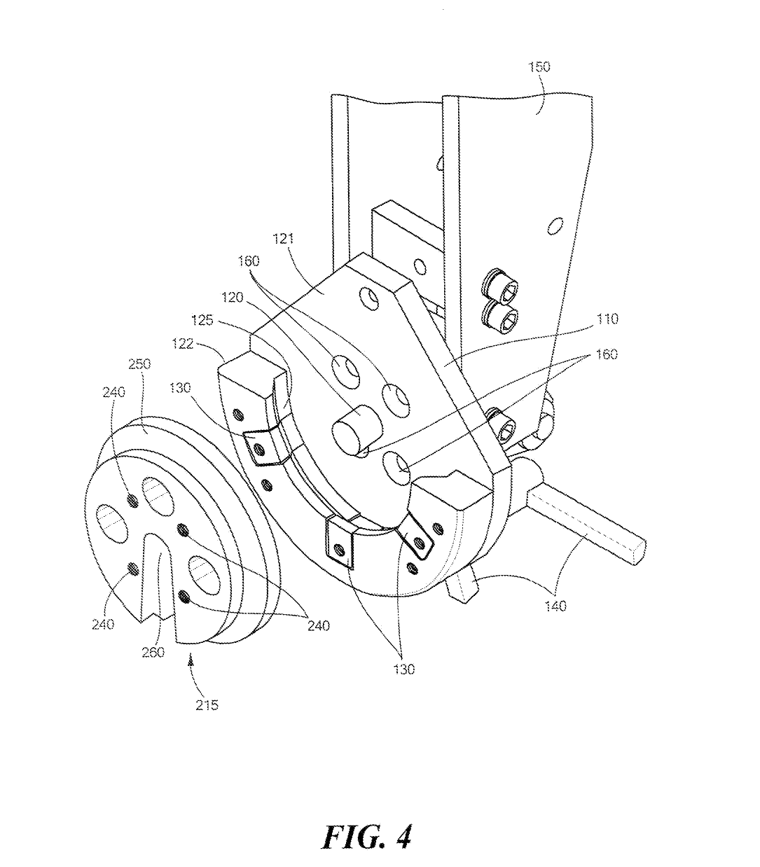

FIG. 4 shows a second exemplary male retaining member 215 for use with the female locating member 110, in accordance with an embodiment of the present invention. In this embodiment, male retaining member 215 is circular and, like the semi-circular male retaining member 210, may be integral to or mounted to the mounting plate 220 or end of arm tool 230, e.g., using threaded holes 240 and bolts (not shown). Circular male retaining member 215 has flange 250 that is configured to fit into groove 125 located on female locating member 110. Additionally, circular male retaining member 215 may include alignment groove 260 that is configured to slide over and rotate about centering pivot pin 120. Alignment groove 260 allows circular male retaining member 215 to be rotated, centered, aligned and adjusted when located within female locating member 110. For reasons discussed below, the male retaining member 215 would typically be oriented on the end of arm tool such that the alignment groove points upward toward the top of the end of arm tool 230.

In order to secure the end of arm tool 230 to the robotic arm 150 using the female locating member 10 and the male retaining member 215, an operator would first align the opening of the alignment groove 260 of the male retaining member 215 with the centering pivot pin 120 of the female locating member 110 and then lower the end of arm tool so that a portion of the flange 250 is within the groove 125. In this position, the end of arm tool would typically be inverted (i.e., upside-down). The robotic arm 150 would substantially bear the weight of the end of arm tool so as to allow the operator to manipulate the end of arm tool, specifically by rotating the end of arm tool approximately 180 degrees so that the end of arm tool is properly positioned. The levers 140 could then be used to lock the male retaining member 215 within the female locating member 110 so as to secure the end of arm tool 230 to the robotic arm 150.

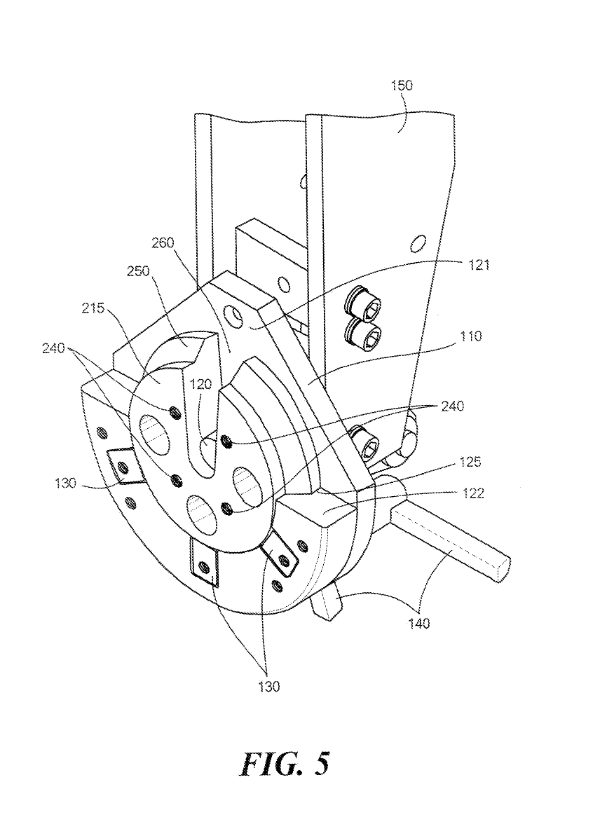

FIG. 5 shows a front perspective view of quick change end of arm tool attachment, with the male retaining member 215 installed in the female locating member 110 in accordance with an embodiment of the present invention. For convenience, the male retaining member 215 is shown without the corresponding mounting plate 220 and end of arm tool 230 in order to provide a clear view of the interaction between the male retaining member and the female locating member 110. The flange 250 sits in the groove 125 and the alignment groove 260 is pointing upward, indicating that the male retaining member 215 has been rotated by approximately 180 degrees from its initial installation position. It can be seen that, in this position, the centering pivot pin 120 prevents upward movement of the male retaining member 215, such that the male retaining member 215 (and, consequently, an attached end of arm tool) cannot be accidentally or purposely removed from the robotic arm. The operator can then turn locking levers 140 to tighten spring loaded cam fingers 130 in order to center and secure the male retaining member 215 in the female locating member 110. When tightened, spring loaded cam fingers 130 will clamp male retaining ring 215 and, therefore, end of arm tool 230, to female locating member 110 and against centering pivot pin 120. It should be noted that the male retaining member 210 is installed in the female locating member 110 in substantially the same way as the male retaining member 215.

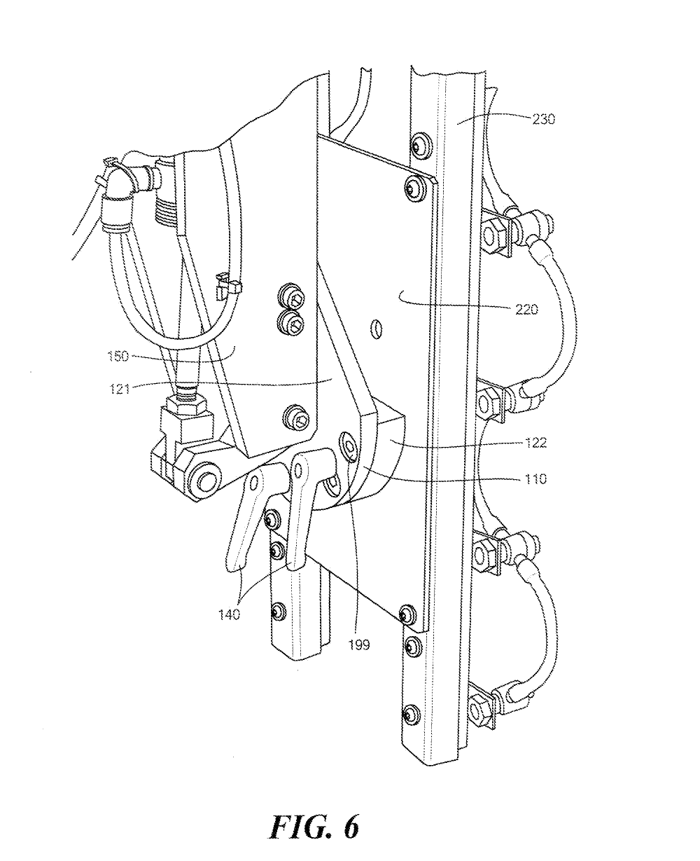

Similarly, FIG. 6 shows a rear perspective view of quick change end of arm tool attachment, with the male retaining member 210 installed in the female locating member 110 in accordance with an embodiment of the present invention. In this example, the mounting plate 220 and end of arm tool 230 are shown. Male retaining member 210 is unable to be seen in this figure because the flat surface of the semi-circular male retaining member 210 is substantially aligned with the top of the rim 122. Again, if an operator wishes to adjust end of arm tool 230, he or she only needs to loosen locking levers 140, adjust the end of arm tool 230 as necessary, and re-tighten locking levers 140.

When an operator wishes to remove and replace an attached end of arm tool with a new end of arm tool, the operator first turns locking levers 140 to loosen spring loaded cam fingers 130. Once loosened, the operator may rotate the end of arm tool and male retaining ring 210/215. Rotating the end of arm tool will put alignment groove 260 in position to slide over centering pivot pin 120. The operator may then slide the end of arm tool and male retaining ring 210/215 out of the female locating member 110. To attach a new end of arm tool, the operator need only slide male retaining member 210/215 into female locating member 110 such that alignment grove 260 slides over centering pivot pin 120 and flange 250 slides into groove 125. Once male retaining ring 210/215 and flange 250 are in place, the operator may rotate the new end of arm tool and male retaining member 210/215. In exemplary embodiments, the operator typically rotates the new end of arm tool by approximately 180 degrees. By rotating new end of arm tool and male retaining ring 210/215, alignment grove 260 can no longer slide over centering pivot pin 120, as shown in FIG. 5. The operator can then turn locking levers 140 to tighten spring loaded cam fingers 130, centering male retaining member 210/215. When tightened, spring loaded cam fingers 130 will clamp male retaining ring 210/215 and, therefore, the new end of arm tool, to female locating member 110 and against centering pivot pin 120.

In practice, the quick change system may be deployed in a manufacturing facility having one or more robots that can be used with various end of arm tools. For example, each robot may be equipped with a female locating member 110, and each of the end of arm tools may be equipped with a male retaining member 210/215. It should be noted that the end of arm tools would not need to be equipped with the same type of male retaining member, but rather some end of arm tools could be equipped with male retaining members of the type 210 and other end of arm tools could be equipped with male retaining members of the type 215. Pre-installing the male retaining member onto the EOATs will ensure that the EOATs are ready for attachment and can be changed rapidly and moved from one robot to another without the need for additional tools.

In the exemplary embodiments described above, male retaining members 210/215 and female locating member 110 are separate add-on parts that are removably installed directly or indirectly (e.g., via a mounting plate) onto the end of arm tool 230 and robotic arm 150, respectively. Such removable parts allow for system flexibility and easy retrofitting of existing robotic arms 150 and end of arm tools 230. However, robotic arm 150 and end of arm tool 230 can also be manufactured such that female locating member 110 is integral to the robotic arm 150 and the male retaining member 210/215 is integral to the end of arm tool 230.

It should be noted that, although FIGS. 3 and 4 show two different types of male retaining members 210 and 215, the present invention is not limited to these embodiments. For example, male retaining members may have an arcuate shape, as well as different configurations, shapes, materials, outline, retaining mechanisms, bolt patterns, flange shape, etc.

It should also be noted that, although FIG. 3 shows the male retaining member 210 attached to mounting plate 220 via bolts, the present invention is not limited to any particular mechanism for coupling the male retaining member to the end of arm tool. For example, male retaining member 210, 215 may be attached to mounting plate in other ways including, but not limited to gluing, welding, clamping, magnets, etc. Alternatively, male retaining member 210, 215 may be integral to mounting plate 220. Further, mounting plate 220 is optional and male retaining member 210, 215 may be attached directly or may be integral to end of arm tool 230.

It should also be noted that, although FIG. 1 shows a female retaining member having a substantially semi-circular rim, the present invention is not limited to any particular female locating member configuration. For example, female retaining member 110 may have different centering mechanisms, locking mechanisms, configuration, shapes, including an arcuate shape, materials, outline, bolt patterns, rim and groove shape and orientation, etc. Furthermore, centering pin 120 and clamps 130 should be considered optional. In embodiments without centering pin 120, male retaining member 210, 215 need not have alignment groove 260.

It should also be noted that, although FIG. 1 further shows female retaining member 110 attached to robotic arm 150 using bolts 115, the present invention is not limited to any particular mechanism for coupling the female locating member to the robotic arm. For example, female retaining member 110 may be attached to robotic arm 150 in other ways including, but not limited to gluing, welding, clamping, etc. Alternatively, female retaining member 110 may be integral to the robotic arm.

It should also be noted that, while the exemplary female locating member 110 includes a separate backplate and rim that are bolted together, the present invention is not limited to such an embodiment. Rather, the backplate and rim can be manufactured from a unitary piece of material or can be coupled using other mechanisms. The rim itself is not required to be of any particular shape. Multiple rim sections can be used to secure the male retaining member.

It should also be noted that, while the exemplary embodiments include cam-type locking mechanism operated by levers, the present invention is not limited to any particular type of locking mechanism.

Although the present invention has been shown and described in terms of specific preferred embodiments, it will be appreciated by those skilled in the art that changes or modifications are possible which do not depart from the inventive concept described and taught herein. Such changes and modifications are deemed to fall within the purview of these inventive concepts. Any combination of various features or the preferred embodiments are deemed to fall within the purview of these inventive concepts.

What is claimed is:

1. An end of arm tool changing system, the system comprising:
a male retaining member for use on an end-of-arm tool, the male retaining member including a flange having at least a convex arcuate portion; and
a female locating member for use on a robotic arm, the female locating member including a rim defining a channel having at least a concave arcuate portion and capable of receiving the flange for coupling the end-of-arm tool to the robotic arm.

2. An end of arm tool changing system in accordance with claim 1, wherein the flange is at least one of semi-circular and circular.

3. An end of arm tool changing system in accordance with claim 1, wherein the retaining member is rotatable within the female locating member to allow for alignment of the end of arm tool with respect to the robotic arm.

4. An end of arm tool changing system in accordance with claim 1, wherein
the female locating member further comprises a center pivoting pin configured to center the male retaining member and attached end of arm tool when the flange is located within the channel of the female locating member; and
the male member further comprises an alignment groove configured to slide over and rotate about the center pivoting pin and ensure the male member is centered in the female member.

5. An end of arm tool changing system in accordance with claim 1 further comprising a plurality of clamps disposed about a perimeter of the female locating member and configured to secure the male retaining member in the channel of the female locating member.

6. An end of arm tool changing system in accordance with claim 5, wherein the plurality of clamps are spring loaded cam fingers.

7. An end of arm tool changing system in accordance with claim 5, further comprising a plurality of locking levers associated with the plurality of clamps and configured to tighten and release spring tension within the plurality of clamps.

8. A quick change end of arm tool comprising a male retaining member including a flange having at least a convex arcuate portion and configured to slide into a rim defining a channel located on a female locating member, wherein the channel has at least a concave arcuate portion.

9. An quick change end of arm tool in accordance with claim 8, wherein the flange is at least one of semi-circular and circular.

10. A quick change end of arm tool in accordance with claim 8, further comprising a mounting plate located on the end of arm tool, wherein the male retaining member is securedly attached to the mounting plate.

11. The quick change end of arm tool of claim 8, wherein the male retaining member further comprises an alignment groove configured to slide over and rotate about a centering pin on the female locating member.

12. A robot comprising a robotic arm including a quick-change female locating member including a rim defining a channel having at least a concave arcuate portion and capable of receiving a flange located on a male retaining member, the male retaining member located on an end-of-arm tool, the flange having at least a convex arcuate portion.

13. A robot in accordance with claim 12, wherein the quick-change female locating member is removeably attached to the robotic arm.

14. A robot in accordance with claim 12, wherein the female locating member further comprises a centering pin configured to center an attached end-of arm tool and male retaining ring.

15. A robot in accordance with claim 12, wherein the female locating member further comprises a plurality of clamps disposed about a perimeter of the female locating member and configured to secure the male retaining member in the channel of the female locating member.

16. A robotic arm in accordance with claim 15, wherein the plurality of clamps are spring loaded cam fingers.

17. A robot in accordance with claim 15, further comprising a plurality of locking levers associated with the plurality of clamps and configured to tighten and release spring tension within the plurality of clamps.

18. A male retaining member for a quick change end-of-arm tool system, the male retaining member comprising:
a plurality of threaded holes for receiving bolts and configured to attach the male quick change end of arm tool attachment to an end-of-arm tool; and
a flange having at least a convex arcuate portion and configured to slide into a rim defining a channel located on a female locating member.

19. A male retaining member for a quick change end-of-arm tool system in accordance with claim 18, wherein the flange is at least one of semi-circular and circular.

20. A male retaining member for a quick change end-of-arm tool system in accordance with claim 18, further comprising an alignment groove configured to slide over and rotate about a centering pin located on the female locating member.

21. A female locating member for a quick change end-of-arm tool system, the female locating member comprising:
a plurality of bolt holes configured to receive bolts and, thereby, attach the female locating member to a robotic arm; and
a rim defining a channel having at least a concave arcuate portion and capable of receiving a flange having at least a convex arcuate portion and located on a male retaining member.

22. A female locating member for a quick change end-of-arm tool system in accordance with claim 21, the female locating member further comprising a plurality of clamps disposed about a perimeter of the female locating member and configured to secure the flange within the channel.

23. A female locating member for a quick change end-of-arm tool system in accordance with claim 22, wherein the clamps are spring loaded cam fingers.

24. A female locating member for a quick change end-of-arm tool system in accordance with claim 22, the female locating member further comprising a plurality of locking levers associated with the plurality of clamps and configured to tighten and release spring tension within the plurality of clamps.

25. A female locating member for a quick change end-of-arm tool system in accordance with claim 21, the female locating member further comprising a center pivoting pin configured to center the male retaining member when the flange is located within the channel.

26. A method of changing end of arm tools on a molding machine having a robotic arm with an attached female locating member, the female locating member having a rim defining a channel, the method comprising:
removing a first end of arm tool from the female locating member, the first end of arm tool including a first male retaining member having a flange situated within the channel of the female locating member, such removing including sliding the flange of the first male retaining member out of the channel; and
installing a second end of arm tool into the female locating member, the second end of arm tool including a second male retaining member having a flange, such installing including sliding the flange of the second male retaining member into the channel.

27. A method of changing end of arm tools in accordance with claim 26, wherein removing the first end of arm tool from the female locating member includes rotating the first end of arm tool such that an alignment groove on the first male retaining member can slide over a centering pin on the female locating member and removing the first end of arm tool from the female locating member such that the alignment groove slides over the centering pin, and wherein installing the second end of arm tool into the female locating member includes sliding an alignment groove on the second male retaining member over the centering pin and rotating the second end of arm tool so that the flange of the second male retaining member is positioned within the channel and the alignment groove on the second male retaining member can no longer slide over the centering pin.

28. A method of changing end of arm tools on a molding machine in accordance with claim 26, further comprising:
turning, in a first direction, a plurality of locking levers located on the female locating member to release spring tension in a plurality of spring loaded clamps and release pressure on the first male retaining member to permit removal of the first end of arm tool; and
turning, in a direction opposite the first direction, the plurality of locking levers to increase spring tension in the plurality of spring loaded clamps and apply pressure to the second male retaining member, centering the second end-of-arm tool and securing the second male retaining member and attached second end of arm tool to the female locating member.

29. A method of changing end of arm tools on a molding machine in accordance with claim 27, wherein rotating the first end of arm tool further comprises rotating the first end of arm tool 180 degrees.

30. A method of changing end of arm tools on a molding machine in accordance with claim 27, wherein rotating the second end of arm tool further comprises rotating the second end of arm tool 180 degrees.
